(19) United States
(12) Patent Application Publication
(10) Pub. No.: US 2019/0291033 A1
(43) Pub. Date: Sep. 26, 2019

(54) DEVICE WITH EXTERNAL DIAPHRAGM FOR ACOUSTIC CLEANING AND AIR PURIFICATION APPLICATIONS

(71) Applicant: Green Energy Engineering Consultancy Limited, Hong Kong (CN)

(72) Inventors: Gin Nam SZE TO, Hong Kong (CN); Nai Kin CHAN, Hong Kong (CN)

(21) Appl. No.: 16/061,599

(22) PCT Filed: Mar. 22, 2018
(86) PCT No.: PCT/CN2018/079957

§ 371 Date: Jun. 12, 2018

(51) Int. Cl. B01D 46/00; B01D 46/48

(52) U.S. Cl. CPC B01D 46/0005; B01D 46/0053; B01D 46/4227; B01D 46/0028; B01D 46/48

(57) ABSTRACT

A device with external diaphragm for acoustic cleaning and air purification is provided. The device comprises a housing with a first opening at a top for receiving one or more acoustic wave generating devices each with a diaphragm attached to a coil; and one or more external diaphragm each covering and sealing the diaphragm attached to the coil to facilitated in protecting the acoustic wave generating device as impurities or materials deposit and accumulate on the external diaphragm instead of the diaphragm of the acoustic wave generating device, and easy cleaning as only the external diaphragm needs to be cleaned, which also avoids damage to the diaphragm of the acoustic wave generating device during cleaning.

### FIELD OF THE INVENTION

The present invention described herein, in general, relates to the field of air cleaning and air purification, and more particularly to a device with external diaphragm for removing the buildup of material on surfaces and/or dust, fine particles, microorganisms and other impurities from air.

### BACKGROUND OF THE INVENTION

Acoustic wave generating device using diaphragm, such as speaker, is used in acoustic cleaning and air purification (Sze To and Chan, US 2017/0197171A1). The acoustic wave generating device has a diaphragm attached to the coil. If this diaphragm is damaged, the acoustic wave generating device will malfunction. In addition, this diaphragm is usually cone-shaped or concaved, making it difficult to clean and maintain.

In acoustic cleaning and air purification, dust, particles and other impurities or materials may deposit and accumulate on the diaphragm of the acoustic wave generating device, which will damage or reduce the performance of the acoustic wave generating device. Attempting to clean the accumulated dust, particles and other impurities on the diaphragm may also damage the diaphragm as the diaphragm is a thin membrane.

### SUMMARY OF THE INVENTION

For the defects in the prior art, an object of the present invention is to provide a device which allows easier cleaning and maintenance of the diaphragm of the acoustic wave generating device.

The technical solutions of the present invention are as follows:

In one aspect, a detector with external diaphragm for acoustic cleaning and air purification applications is provided, which comprises: a housing with a first opening at a top for receiving one or more acoustic wave generating devices each with a diaphragm attached to a coil; and one or more external diaphragm each covering and sealing the diaphragm attached to the coil to facilitated in protecting the acoustic wave generating device as impurities or materials deposit and accumulate on the external diaphragm instead of the diaphragm of the acoustic wave generating device, and easy cleaning as only the external diaphragm needs to be cleaned, which also avoids damage to the diaphragm of the acoustic wave generating device during cleaning.

Advantageously, the one or more external diaphragm each covers and seals the diaphragm attached to the coil along the edge of the first opening on the top of the housing.

Advantageously, a second opening is defined on at a bottom of the housing.

Advantageously, the one or more external diaphragm each covers and seals the diaphragm attached to the coil along the edge of the second opening at the bottom of the housing.

Advantageously, the device further comprises a horn attached to the top of the housing, a third opening is defined at a top of the horn and the external diaphragm covers and seals the third opening of the horn so as to cover and seal the diaphragm attached to the coil.

Advantageously, the external diaphragm has a predominantly flat surface and edge made with elastic material.

Advantageously, the impurities comprise one or more of dust, particles, airborne microorganism, virus and allergens.

The device in this disclosure encloses or semi-encloses one or multiple acoustic wave generating devices. The acoustic wave generated by the acoustic wave generating device can be transmitted outside the invented device through an external diaphragm, that is, another diaphragm that is not attached to the coil of the acoustic wave generating device. This invented device allows impurities or materials to deposit and accumulate on its external diaphragm instead of the diaphragm attached to the coil of the acoustic wave generating device. The middle part of the external diaphragm is a flat surface, which allows easy cleaning of the accumulated dust, particles and other impurities on it.

The device in the present disclosure allows easier cleaning and maintenance due to its shape. It also protects the acoustic wave generating device as the impurities or materials deposit and accumulate on the external diaphragm instead of the diaphragm of the acoustic wave generating device. When performing cleaning, only the external diaphragm needs to be cleaned. This avoids damage to the diaphragm of the acoustic wave generating device.

### BRIEF DESCRIPTION OF THE DRAWINGS

FIG. 1 is a cross-sectional view of a device with external diaphragm for acoustic cleaning and air purification applications according to one embodiment of the present invention;

FIG. 2 is a cross-sectional view of a device with external diaphragm for acoustic cleaning and air purification applications according to another embodiment of the present invention;

FIG. 3 is a cross-sectional view of a device with external diaphragm for acoustic cleaning and air purification applications according to yet another embodiment of the present invention;

FIG. 4 is a cross-sectional view of a device with external diaphragm for acoustic cleaning and air purification applications according to yet another embodiment of the present invention.

### DETAILED DESCRIPTION OF THE EMBODIMENTS

The present invention will now be more particularly described, by way of example only, with reference to the accompanying drawings. It should be understood that the drawing are for better understanding and should not limit the present invention. Dimensions of components and features shown in the drawings are generally chosen for convenience and clarity of presentation and are not necessarily shown to scale.

This disclosure may, however, be embodied in many different forms and should not be construed as limited to the embodiments set forth herein. Rather, these embodiments are provided so that this disclosure will be thorough and complete, and will fully convey the scope of the disclosure to those skilled in the art. Like reference numerals refer to like elements throughout. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise.

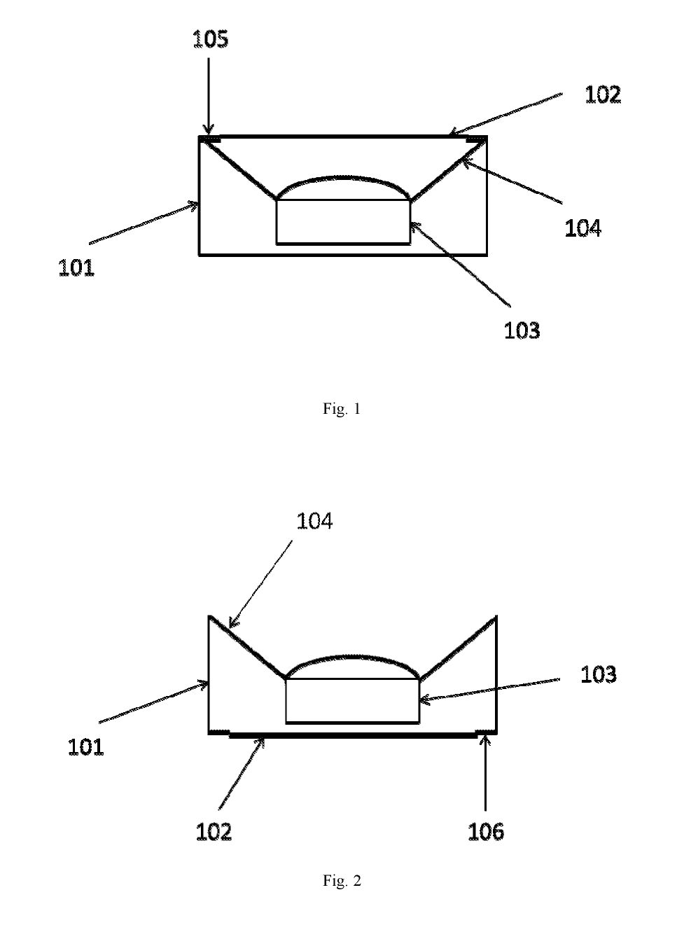

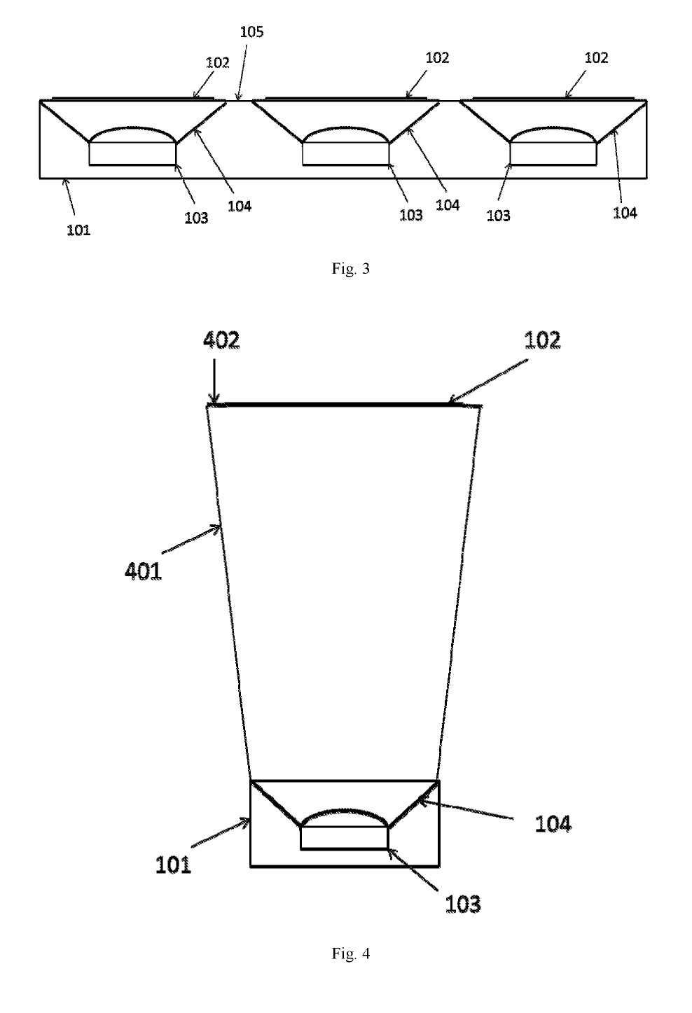

Referring to FIGS. 1 and 3, the device for acoustic cleaning and air purification applications comprises a housing 101 with a first opening 105 at a top for receiving one or more acoustic wave generating devices (see FIG. 3) each with a diaphragm 104 attached to a coil 103, and one or more external diaphragm 102 each covering and sealing the diaphragm 104 attached to the coil 103 to facilitated in protecting the acoustic wave generating device as impurities or materials deposit and accumulate on the external diaphragm 102 instead of the diaphragm 104 of the acoustic wave generating device, and easy cleaning as only the external diaphragm 102 needs to be cleaned, which also avoids damage to the diaphragm 104 of the acoustic wave generating device during cleaning. The housing 101 and the external diaphragm 102 form an acoustic enclosure with the diaphragm 104 attached to the coil 103. The external diaphragm 102 covers and seals the diaphragm 104 along the edge of the housing 101, i.e. edge of the opening. The external diaphragm 102 has a predominantly flat surface and edge made with elastic material to allow easy cleaning when dust, particles and other impurities accumulated on it. The impurities comprise one or more of dust, particles, airborne microorganism, virus and allergens.

Further referring to FIG. 2, the housing 101 has an additional opening 106 at the bottom. The external diaphragm 102 covers and seals the diaphragm 104 attached to the coil along the edge of the opening 106 at the bottom of the housing 101. The housing 101 and the external diaphragm 102 form an acoustic enclosure with the diaphragm 104 attached to the coil 103. This configuration is used when the coil 103 and the diaphragm 104 are used to generate acoustic wave to the top direction for purposes such as generating sound, while some of the acoustic wave energy transmitted to the bottom direction is to be used in acoustic cleaning and air purification applications.

Referring to FIG. 3, the housing 101 may be designed and sized to receive multiple acoustic wave generating devices. The housing 101 hosted multiple diaphragms 104 and coils 103 forming a single acoustic enclosure. The external diaphragms 102 cover and seal the diaphragms 104. It should be understood that the configuration illustrated in FIG. 2 can also be configured into a single acoustic enclosure with multiple acoustic wave generating devices.

Referring to FIG. 4, the device for acoustic cleaning and air purification applications may also comprise a horn 401 attached to the top of the housing 101, another opening 402 is defined at a top of the horn 401 and the external diaphragm 102 covers and seals the opening 402 of the horn 401 so as to cover and seal the diaphragm 104 attached to the coil 103.

The device in this disclosure encloses or semi-encloses one or multiple acoustic wave generating devices. The acoustic wave generated by the acoustic wave generating device can be transmitted outside the invented device through an external diaphragm, that is, another diaphragm that is not attached to the coil of the acoustic wave generating device. This invented device allows impurities or materials to deposit and accumulate on its external diaphragm instead of the diaphragm attached to the coil of the acoustic wave generating device. The middle part of the external diaphragm is a flat surface, which allows easy cleaning of the accumulated dust, particles and other impurities on it.

Although the invention is described with reference to one or more preferred embodiments, it should be appreciated by those skilled in the art that various modifications are possible. Therefore, the scope of the invention is to be determined by reference to the claims that follow.

We claim:

1. A device, comprising:
a housing with a first opening at a top for receiving one or more acoustic wave generating devices each with a diaphragm attached to a coil; and
one or more external diaphragm each covering and sealing the diaphragm attached to the coil to facilitated in
protecting the acoustic wave generating device as impurities or materials deposit and accumulate on the external diaphragm instead of the diaphragm of the acoustic wave generating device, and
easy cleaning as only the external diaphragm needs to be cleaned, which also avoids damage to the diaphragm of the acoustic wave generating device during cleaning.

2. The device of claim 1, wherein the one or more external diaphragm each covers and seals the diaphragm attached to the coil along the edge of the first opening on the top of the housing.

3. The device of claim 1, wherein a second opening is defined on at a bottom of the housing.

4. The device of claim 3, wherein the one or more external diaphragm each covers and seals the diaphragm attached to the coil along the edge of the second opening at the bottom of the housing.

5. The device of claim 1, wherein, the device further comprises a horn attached to the top of the housing, a third opening is defined at a top of the horn and the external diaphragm covers and seals the third opening of the horn so as to cover and seal the diaphragm attached to the coil.

6. The device of claim 1, wherein the external diaphragm has a predominantly flat surface and edge made with elastic material.

7. The device of claim 1, wherein the impurities comprise one or more of dust, particles, airborne microorganism, virus and allergens.
